(19) United States
(12) Patent Application Publication
(10) Pub. No.: US 2006/0242099 A1
(43) Pub. Date: Oct. 26, 2006

(54) Sensitivity analysis in probabilistic argumentation systems

(75) Inventors: Yang Chen, Westlake Village, CA (US); Deepak Khosla, Calabasas, CA (US)

Correspondence Address: THOMAS J. FINN;RAYTHEON COMPANY/EO/E4/N119, 2000 E. El Segundo Blvd., P.O. Box 902, El Segundo, CA, 90245-0902, US

(73) Assignee: RAYTHEON COMPANY

(21) Appl. No.: 11/111,359

(22) Filed: Apr. 20, 2005

(51) Int. Cl. G06N 5/02

(52) U.S. Cl. 706/47

(57) ABSTRACT

A sensitivity analysis method is built upon a PAS framework that includes a knowledge base defined by a set of propositions, a set of logical statements over the propositions, a set of assumptions for each statement and the corresponding assumption probabilities. The knowledge base is queried to determine the quasi-support qs(H) and qs(⊥). Disjoint arguments of the quasi-support are then found for both the hypothesis H and contradiction ⊥. Symbolic formulas dqs(H) and dqs(⊥) are formed for the degree of quasi-support for hypothesis H and contradiction ⊥, respectively, based on these disjoint arguments. The partial derivatives

$${D}_{H , j} ≡ \frac{\partial dqs ( H )}{\partial {r}_{j}} of dqs ( H ) and {D}_{⊥ , j} ≡ \frac{\partial dqs ( ⊥ )}{\partial {r}_{j}}$$

of dqs(⊥) are computed with respect to the assumption probability rⱼ. Sensitivity analysis formulas ƒ(H,D_{H,j},D_{⊥,j},rⱼ,δrⱼ) are then formed from the partial derivatives to establish the relationship between a PAS output, such as the degree of support dsp( ), degree of doubt ddb( ), and degree of possibility dps( ), for hypothesis H, and the assumption probabilities under a given input condition. The formulas can be used to determine how to tune the assumption probabilities to achieve the desired PAS output values, to identify key assumption probabilities, to measure the sensitivity of the system to the assumption probabilities, to account for input variability, to identify contradictions in the knowledge base and so forth.

### BACKGROUND OF THE INVENTION

1. Field of the Invention

This invention relates to sensitivity analysis in an uncertain reasoning system to establish the relationship between the system output and the system parameters under a given input condition, and more specifically to a sensitivity analysis method built upon a Probabilistic Argument System (PAS) framework.

2. Description of the Related Art

Sensitivity analysis in an uncertain reasoning system refers to the analysis of the relationship between the system output and the system parameters under a given input condition. Such a relationship helps quantify the effects of each parameter to the system output, and thus allows designers to build better reasoning systems by providing guidance as to which system parameters to change and how to tune them to achieve the desired inference results. This relationship can also be used to identify “key” parameters, to ascertain the sensitivity of parameters and so forth.

Sensitivity analysis has been studied in the context of explaining evidential reasoning results (T. Strat and J. Lawrence, “Explaining Evidential Analyses,” International Journal of Approximate Reasoning, Vol. 3, pp. 299-353. 1989 and H. Xu and P. Smets, “Generating Explanation for Evidential Reasoning,” Proc. of the 11^{th} Annual Conference on Uncertainty in Artificial Intelligence, Montreal, Quebec, Canada. Aug. 18-20, 1995) and in Bayesian networks starting in the 1990's for tuning network parameters (K. Laskey, “Sensitivity Analysis for Probability Assessments in Bayesian Networks,” Proc. of the 9^{th} Annual Conference on Uncertainty in Artificial Intelligence, Washington D.C., USA. Jul. 9-11, 1993 and E. Castilli et al., “Sensitivity Analysis in Discrete Bayesian Networks,” IEEE Trans. on SMC-A Vol. 27, No. 4, July 1997. pp. 412-423), and for explaining Bayesian network behaviors (M. Henrion, et al., “Why is diagnosis using belief networks insensitive to imprecision in probabilities?” Proc. of the 12^{th} Annual Conference on Uncertainty in Artificial Intelligence, Portland, Oreg., USA. Aug. 1-4, 1996). The most comprehensive work in sensitivity analysis in Bayesian networks is probably that by H. Chan and A. Darwiche (“When do Numbers Really Matter?” Journal of Artificial Intelligence Research, Vol. 17, pp. 265-287, September 2002). Their work solves most of the dangling questions that have been puzzling the Bayesian network community related to the explanation of network behavior, and gives concise and comprehensive formulations to assessing the sensitivity of a Bayesian network, including bounds of inference results due to changes in network parameters.

In recent years, the probabilistic argumentation system (PAS) has emerged as a viable alternative for reasoning under uncertainty to Bayesian reasoning. The appeal of the PAS rests not only in its approach of combining classic proposition logic and probabilistic reasoning to address a broader problem space than Bayesian reasoning, but also in its natural connection with and equivalence to the Dempster-Shafer (D-S) evidential reasoning framework. In fact every PAS system can be implemented using a set of corresponding D-S belief functions. Furthermore, PAS can be used to represent any Bayesian network although in practice Bayesian formulations would be preferred due to lower computational complexity. An advantage of using PAS is that it gives “arguments” for a given hypothesis, which can be used as an explanation of the reasoning result.

### Probabilistic Argumentation System (PAS)

Probabilistic argumentation systems as described in detail in R. Haenni, J. Kohlas and N. Lehmann, “Probabilistic Argumentation Systems,” Technical Report 99-9 Institute of Informatics, University of Fribourg, Fribourg, Switzerland. 1999; J. Kohlas and R. Haenni “Assumption-Based Reasoning and Probabilistic Argumentation Systems”, Technical Report 96-07 Institute of Informatics, University of Fribourg, 1996; and B. Anrig, R. Bissig, R. Haenni J. Kohlas, and N. Lehmann, “Probabilistic Argumentation Systems: Introduction to Assumption-Based Modeling with ABEL”, Institute of Informatics, University of Fribourg, 1998, which are hereby incorporated by reference, are an implementation of the theory of hints (J. Kohlas and P. Monney, “A Mathematical Theory of Hints. An Approach to the Dempster-Shafer Theory of Evidence” 425 Lecture Notes in Economics and Mathematical Systems, Springer, 1995).

According to the theory of hints a knowledge base is explicitly encoded as logic clauses with associated uncertainties. The logic clauses or statements are either single logic variables (called propositions) or statements derived from standard logic operations on a set of propositions. Each proposition takes on a number of discrete values and can be either Boolean or multi-valued. The logic operations allowed are the standard propositional logic operations (AND, OR, NOT, IMPLIES). The uncertainty of a logic clause is expressed by attaching assumptions with it. The assumptions are a set of logic variables themselves and have an assigned probability value. Thus propositions and assumptions are two disjoint sets of logic variables that are combined by standard logic operators to form uncertain logic clauses. The uncertainty of an uncertain logic clause is quantified by the probability of the assumptions that appear in its body.

Proposition set P={p₁, . . . , pₙ}, where elements pᵢ are propositions

Assumption set A={a₁, . . . , aₙ}, where elements aᵢ are assumptions

Extended assumption set A_{E}={a₁, ˜a₁, . . . , aₙ, ˜aₙ}

Let the set R={r₁, . . . , rₙ}={Pr(a₁), . . . Pr(aₙ)} denote the probabilities of the assumptions a₁, . . . , aₙ, respectively.

Let the set of all logic statements obtained by the standard propositional logic operators on these disjoint sets be denoted by S. The knowledge base K is a subset of S. The problem is then fully specified by the quadruple (P, A, R, K).

This combination of classical logic and probability theory is a unique feature and the underlying principle of a PAS system. Given such a knowledge base, the problem is then to find arguments for hypotheses (queries). A hypothesis is a logic sentence that represents some of the open questions or statements about the uncertain knowledge base. More precisely, a hypothesis H is a logical sentence formed from basic propositions {p₁, . . . , pₙ} in the knowledge base. For example (P₁ [symbol] p₂) and (p₁ [symbol] ˜p₂) are examples of H. PAS utilizes a logic resolution process to derive arguments that support and refute hypotheses of interest. These arguments are built from the assumptions appearing in the knowledge base K and are conjunctions or/and disjunctions of the assumptions. To quantify a hypothesis, the system combines probabilities of the arguments themselves based on the assumptions that appear in the derived arguments. PAS therefore provides both a quantification of belief in a hypothesis and the logic-based arguments that lead to this belief

The following terms are most commonly encountered in PAS:

contradiction (⊥): The state of the knowledge base, plus any hypothesis, in which not all statements (including the hypothesis) can be satisfied (i.e., being true) at the same time;

quasi-support of H(qs(H)): The arguments (or conditions) that make either hypothesis H true or make the knowledge base a contradiction ⊥. The arguments are typically represented as disjunctions of conjunctions of assumptions, or their negations;

support of H(sp(H): The arguments that make hypothesis H true, but not contradiction ⊥;

degree of quasi-support of H(dqs(H)): The probability of the quasi-support; and

degree of support of H(dsp(H):) The probability of support.

The quasi-support qs(H) of a hypothesis His a disjunctive normal formula (DNF) of the form
qs(H)=con(α₁) [symbol] . . . [symbol] con(α₁) (1)
where αᵢ⊂A_{E},i=1, . . . , l, are sets of assumptions, con(αᵢ) is the conjunction of elements aεαᵢ, and is called an argument supporting H. For simplicity, when there is no ambiguity, an argument con(αᵢ) is referred to simply as αᵢ. The set of disjunctive arguments is called the set of minimal quasi-supporting arguments of hypothesis H. The degree of quasi-support dqs(H) is then the probability of qs(H) and can be computed from the probabilities of arguments which in turn depend on the probability of the assumptions that appear in them. However since the arguments αᵢ are not necessarily disjoint, the calculation of the dqs(H) is not straightforward.

To make the probability calculation easier, the DNF above is converted into an equivalent DNF of the form:
qs(H)=con(β₁) [symbol] . . . [symbol] con(βₘ), (2)
where each argument con(βᵢ) is still a conjunction of assumptions, βᵢ⊂A_{E}, but now the arguments βᵢ are mutually disjoint. This implies that the system state for arguments βᵢ and βⱼ are disjoint for ∀i≈j. βᵢ and βⱼ are disjoint arguments if the negation of at least one assumption literal appearing in βᵢ appears in βⱼ. This means that under the set of assumptions for which argument con(βᵢ) is true, con(βᵢ) is false and vice versa. Also note that in general m≈l. Denote the set of disjoint arguments of quasi-support for H:
S_{qs}(H)={β₁, . . . , βₘ} (3)

The conversion to the equivalent disjoint DNF form shown in Eq. (2) can be done by a method proposed by Abraham (B. Anrig, “A Generalization of the Algorithm of Abraham”, Proceedings of MMR 2000, Second International Conf. On Mathematical Methods in Reliability, Bordeaux, France). The probability of each argument βᵢ is then simply a product of the probabilities of the assumptions that appear in it. The most general form of this probability is:

$$Pr ( con ( {β}_{i} ) ) = {\prod }_{x ∈ {β}_{i}} Pr ( x ) , \\ where \\ Pr ( x ) = \{ \begin{matrix}{r}_{j} , & if x = {a}_{j} , {a}_{j} ∈ {β}_{i} \\ 1 - {r}_{j} , & if x = \sim {a}_{j} , \sim {a}_{j} ∈ {β}_{i}\end{matrix} \qquad ( 4 )$$

and rⱼ is the probability of assumption aⱼ. Here it is assumed that each assumption is independent of the other assumptions, and the assumptions can appear in either original or negated forms in an argument.

The degree of quasi-support dqs(H) is then simply the sum of the probabilities of the individual arguments βᵢ:

$$dqs ( H ) = {\sum }_{{β}_{i} ∈ {S}_{qs} ( H )} Pr ( con ( {β}_{i} ) ) = {\sum }_{{β}_{i} ∈ {S}_{qs} ( H )} ( {\prod }_{x ∈ {β}_{i}} Pr ( x ) ) \qquad ( 5 )$$

The above approach and equations applies to any hypothesis or query H. Thus H can include queries such as contradiction or tautology as well. dqs(⊥) is computed by substituting ⊥ for H in Eq. (5).

One of the most common queries in PAS is the degree of support dsp(H) (corresponding to the normalized belief of H in D-S reasoning) which is given by:

$$dsp ( H ) = \frac{dqs ( H ) - dqs ( ⊥ )}{1 - dqs ( ⊥ )} \qquad ( 6 )$$

Thus, the computation of dqs(H) and dqs(⊥) provides an expression for dsp(H). Note that dsp(H) is a function of all the assumption probabilities rⱼ's that appear in dqs(H) and dqs(⊥). For convenience of future reference, we define R_{dqs(H)} and R_{dqs(⊥)} as the sets of assumption probabilities that appear in dqs(H) and dqs(⊥), respectively.

### SUMMARY OF THE INVENTION

The present invention provides a sensitivity analysis method built upon a Probabilistic Argument System (PAS) framework.

A sensitivity analysis method is built upon a PAS framework that includes a knowledge base defined by a set of propositions, a set of logical statements over the propositions, a set of assumptions for each statement and the corresponding assumption probabilities. The knowledge base is queried to determine the quasi-support qs(H) or qs(⊥). Disjoint arguments of the quasi-support are then found for both the hypothesis H and contradiction ⊥. Symbolic formulas dqs(H) and dqs(⊥) are formed for the degree of quasi-support for hypothesis H and contradiction ⊥ based on these disjoint arguments. The partial derivatives

$${D}_{H , j} ≡ \frac{\partial dqs ( H )}{\partial {r}_{j}}$$

of dqs(H) and

$${D}_{⊥ , j} ≡ \frac{\partial dqs ( ⊥ )}{\partial {r}_{j}}$$

of dqs(⊥) are computed with respect to the assumption probability rⱼ. Sensitivity analysis formulas ƒ(H,D_{H,j},D_{⊥,j},rⱼ,δrⱼ), are then formed from the partial derivatives to establish the relationship between a PAS output, such as the degree of support dsp( ), degree of doubt ddb( ), and degree of possibility dps( ), for hypothesis H, and the assumption probabilities under a given input condition. The formulas can be used to determine how to tune the assumption probabilities to achieve the desired PAS output values, to identify key assumption probabilities, to measure the sensitivity of the system to the assumption probabilities, to account for input variability, to identify contradictions in the knowledge base and so forth.

These and other features and advantages of the invention will be apparent to those skilled in the art from the following detailed description of preferred embodiments, taken together with the accompanying drawings, in which:

### BRIEF DESCRIPTION OF THE DRAWINGS

FIGS. 1 and 2 are a system diagram and flowchart for sensitivity analysis built upon a PAS framework in accordance with the present invention; and

FIGS. 3 through 5 are diagrams of a knowledge base, graph representation and sensitivity analysis for an exemplary parameter tuning problem.

### DETAILED DESCRIPTION OF THE INVENTION

The general problem of sensitivity analysis in an uncertain reasoning system is to analyze the relationship between the system output and the system parameters under a given input condition. Such a relationship helps to quantify the effects of each parameter to the system and to build better reasoning systems by guiding the system designers as to which system parameters to change and how to tune them. For example, the relationship can be used to determine how to tune certain parameters to achieve desired PAS outputs, to identify key parameters, to measure the sensitivity of parameters, to account for input variability, to identify contradictions in the knowledge base and so forth. Although the queries asked and the functionalities for performing sensitivity analysis are similar to those taught by Chan and Darwich for Bayesian networks, the problem formulation and implementation in a PAS framework, hence the solutions are different. Such a method will allow reasoning system designers to utilize the more powerful PAS framework to address a broader scope of problems than is supported by Bayesian reasoning.

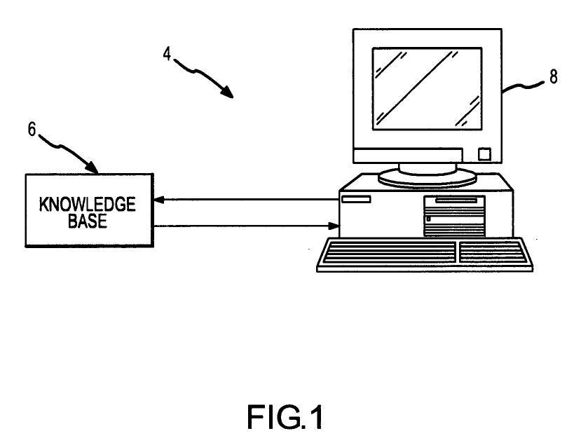

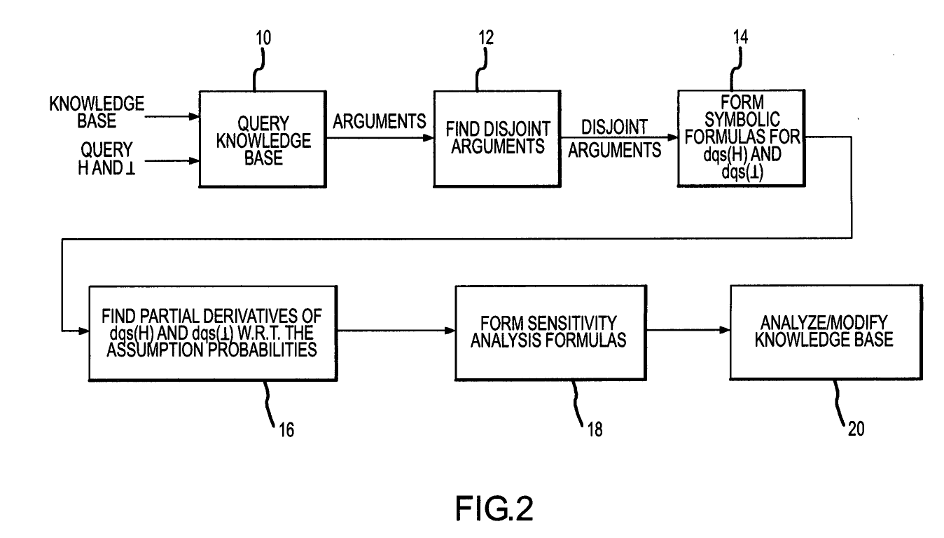

As shown in FIGS. 1 and 2, a sensitivity analysis method is built upon a Probabilistic Argument System (PAS) framework 4 including a knowledge base 6 defined by a set of propositions, a set of logical statements over the propositions, a set of assumptions for each statement and the corresponding assumption probabilities provided by a knowledge base designer and a logic resolution process implemented on a computer 8. The knowledge base itself may be stored either on a separate device or the computer. A designer will generate the particular problem formulation, e.g. parameter tuning, sensitivity etc., using the logic resolution processes for the computer to query the knowledge base and generate the corresponding sensitivity analysis formulas. These formulas are then used to analyze and/or modify the knowledge base 6.

Although the sensitivity analysis problem is posed as the relationship between the system output and the system parameters under a given input condition, the actual input condition is not expressed in the formulations. Instead any system inputs are converted into equivalent logic statements with associated assumptions and assumption probabilities in the knowledge base and treated the same as any other logical statements.

To perform sensitivity analysis, the requisite symbolic formulas must first be derived from the PAS framework. Accordingly, the computer issues a query (hypothesis H) constructed by the designer to the knowledge base (step 10) to determine the quasi-support qs(H) that will make a hypothesis H true or make the knowledge base a contradiction ⊥, if conditions in the arguments are met given the knowledge base. More specifically, the query process uses logic resolution algorithms (e.g., Haenni supra) to find conditions that make the hypothesis H true given the knowledge base or make the knowledge base unsatisfiable (i.e., resulting in a contradiction). These conditions can be represented as disjunctions of conjunctions of assumptions, or their negations, representing logical statements in the knowledge base. Each of these conditions is an argument for the conclusion (hypothesis true or contradiction), and they are qualitative because the assumptions representing the logical statements are considered to be either true or false, whereas the knowledge base assigns probabilities to the assumptions.

Next, the computer finds disjoint arguments of the quasi-support for both the hypothesis H and the contradiction ⊥(step 12). This process as detailed in equations 2-4 above finds a different representation of the arguments for the quasi-support in that only one argument can be true at a time. This ensures that the probability calculation for degree of the quasi-support (see below) will not double count any contributing assumption probabilities, and thus will be accurate.

Finally, the computer forms symbolic formulas for the degrees of quasi-support for hypothesis H, dqs(H) (Eq. (5)), and contradiction ⊥, dqs(⊥), based on the disjoint arguments for H and ⊥ (step 14). The assumptions in the disjoint quasi-support arguments are replaced with the assumption probabilities, the conjunction operators are replaced with multiplication operators, and the disjunction operators are replaced with addition operators.

Once provided with the symbolic formulas, the sensitivity analysis process computes the partial derivatives of dqs(H) and dqs(⊥) with respect to the assumption probabilities (step 16). Since the degree of quasi-support formula are typically first-order equations (under the binary or multi-state conditions given in detail later), the partial derivatives of dqs(H) and dqs(⊥) with respect to the assumption probabilities are constants given by:

$$\begin{matrix}{D}_{H , j} ≡ \frac{\partial dqs ( H )}{\partial {r}_{j}} & ( 7 ) \\ and & \\ {D}_{⊥ , j} ≡ \frac{\partial dqs ( ⊥ )}{\partial {r}_{j}} & ( 8 )\end{matrix}$$

These partial derivatives provide the building blocks for the construction of sensitivity analysis formulas.

Sensitivity analysis formulas are formed from the partial derivatives, and establish the relationship between a PAS output and the assumption probabilities under a given input condition (step 18). In general, the sensitivity analysis formulas are given as a function:
ƒ(H,D_{H,j},D_{⊥,j},rⱼ,δrⱼ) (9)
where H is the hypothesis; rⱼ and δrⱼ are certain assumption probability and the differential changes of the assumption probability, respectively; D_{H,j} and D_{⊥,j} are the partial derivatives of dqs(H) and dqs(⊥), respectively, with respect to the assumption probability rⱼ; and ƒ( ) is one of many possible functions that establish the relationship between a PAS output, such as the degree of support dsp(H), degree of possibility dps(H)=1-dsp(˜H)=(1-dqs(˜H))/(1-dqs(⊥)), and degree of doubt ddb(H)=dsp(˜H), for hypothesis H, and the assumption probabilities under a given input condition (Haenni supra). The precise formulation of these equations will depend on the type of sensitivity analysis performed and the PAS output evaluated.

The formulas are then used to analyze and/or modify (qualitatively or quantitatively by the designer(s) or computer) the knowledge base (step 20). As detailed below, sensitivity analysis may be used to determine how to tune the assumption probabilities to achieve certain PAS outputs. In this case, a designer may have defined the basic PAS framework and the I/O relationship but the initial assumption probabilities may not be sufficient to achieve the expected output. Other types of sensitivity analysis that may be performed include identifying the most sensitive assumptions to focus more resources to ensure the accuracy of the associated assumption probabilities, identifying the most important assumptions to simplify the network or provide more resources to support those assumptions, incorporating input variability, etc. These tasks may also be performed using any of the PAS outputs mentioned above.

Partial Derivatives—Binary Assumptions

If all logical statements in the knowledge base stand on their own rights then, in PAS terms, the assumptions are binary in the sense that only the assumption literal or its negation appears in any disjoint arguments (see Eq. (4)). In other words, all the assumption probabilities rⱼ=Pr(aⱼ) are mutually independent and free to take any value between 0 and 1. Therefore changing an assumption probability Pr(aⱼ) by a certain amount also means changing Pr(˜aⱼ) in the opposite direction by the same amount.

As shown in Eq. (5), the degree of quasi-support, dqs(H), is a function of assumption probabilities in “multi-linear” form. The partial derivatives of dqs(H) with respect to rⱼ=Pr(aⱼ) based on Equations (5) and (4) are computed as follows, noting the assumptions in arguments present in βᵢ are disjoint:

$${D}_{H , j} ≡ \frac{\partial dqs ( H )}{\partial {r}_{j}} = {\sum }_{{{β}_{i} ∈ {S}_{qs} ( H ) ,}_{{β}_{i} ⋀ ( {a}_{j} ⋁ \sim {a}_{j} ) \neq ∅}} {( - 1 )}^{s ( {a}_{j} )} {\prod }_{x ∈ {β}_{i} - \{ {a}_{j} , \sim {a}_{j} \}} Pr ( x ) \qquad ( 10 )$$

where aⱼεβᵢ or ˜aⱼεβᵢ (but not both by virtue of disjoint arguments), βᵢεS_{sq}(H), and

$$s ( {a}_{j} ) = \{ \begin{matrix}0 , & if {a}_{j} ∈ {β}_{i} \\ 1 , & if \sim {a}_{j} ∈ {β}_{i}\end{matrix}$$

Similarly, the partial derivative of dqs(⊥) with respect to rⱼ is computed as follows:

$${D}_{⊥ , j} ≡ \frac{\partial dqs ( ⊥ )}{\partial {r}_{j}} = {\sum }_{{{β}_{i} ∈ {S}_{qs} ( ⊥ ) ,}_{{β}_{i} ⋀ ( {a}_{j} ⋁ {a}_{j} ) \neq ∅}} {( - 1 )}^{s ( {a}_{j} )} {\prod }_{x ∈ {β}_{i} - \{ {a}_{j} , \sim {a}_{j} \}} Pr ( x ) \qquad ( 11 )$$

Sensitivity Analysis Formulations—Binary Assumptions

Sensitivity analysis formulas ƒ(H, D_{H,j}, D_{⊥,j},rⱼ, δrⱼ) are then formed from the partial derivatives to establish the relationship between a PAS output, such as the degree of support dsp( ), degree of doubt ddb( ), and degree of possibility dps( ), for hypothesis H, and the assumption probabilities under a given input condition. As described below, the formulas can be used to measure the sensitivity of the system to the assumption probabilities, determine how to tune the assumption probabilities to achieve the desired PAS output values and so forth.

### Parameter Sensitivity

The term “sensitivity” implies the magnitude of change in system output in relation to the system parameters. One measure of sensitivity is the partial derivative of the PAS output with respect to the system parameters. For example, the sensitivity (wⱼ) of dsp(H) to the value of any assumption probability rⱼ is given by its partial derivative with respect to that probability at its current value rⱼ₀:

$${w}_{j} = {[ \frac{\partial dsp ( H )}{\partial {r}_{j}} ]}_{{r}_{j 0 }} , {r}_{j} ∈ {R}_{dsp ( H )} \qquad ( 12 )$$

where R_{dp(H)} is the set of assumption probabilities that appear in dsp(H). Eq. (12) defines a vector of “sensitivity values” wⱼ for a specific hypothesis with respect to the set of system parameters, i.e., the assumption probabilities. Since equations (5) and (6) provide a closed-form formula for dsp(H), the sensitivity values can be computed using Eq. (12) exactly once the arguments βᵢ are obtained and the partial derivatives of dqs(H) and dqs(⊥) computed using Eq. (10) and (11).

The sensitivity values can be used to rank-order the influence of the assumption probabilities to dsp(H) according to their absolute values:
RO dsp(H)=Rank Order [wⱼ], ∀j,rⱼεR_{dp(H)} (13)

A large (absolute) sensitivity value indicates that a relatively small change in the corresponding assumption probability will bring about a relatively large change in dsp(H). Similarly, a small (absolute) sensitivity value means that dsp(H) is relatively immune to changes in the corresponding assumption probability. This analysis tells a designer to construct the system to ensure that the most sensitive assumption probabilities have correct values to ensure high confidence reasoning results.

### Parameter Tuning

Sensitivity analysis functionality equivalent to that provided by Chan and Darwiche for Bayesian networks can be developed for knowledge bases in the PAS framework. In this case, the assumption probabilities to tune must be found and the amount by which each must be changed calculated to satisfy certain constraints (either ratio or difference constraint) over two system outputs. Chan and Darwiche showed a way to solve this problem in the Bayesian reasoning framework using Bayesian networks. With PAS and the method described above, the same sensitivity question can be solved using either an exact or approximate methodology described below even for a problem in which the knowledge base is not amendable to a Bayesian solution.

Sensitivity analysis can help determine if the assumptions in the given knowledge base can be changed to achieve certain inference goals. In this example the change needed in the value of elements of the set R_{dp(H)} to achieve a certain specified goal, e.g., a new value of dsp(H) is determined. Formally, this can be stated as:
Find δrⱼ such that dsp(H, rⱼ+δrⱼ)=ε (14)

If a different function other than dsp( ) is used, the exact formulas will be different.

Exact (Closed-Form) Method

To find an exact (closed-form) solution for the hypothesis H posed in Eq. (14), we note that since the partial derivatives in Eq. (10) and (11) are constant with respect to rⱼ, changes in dqs(H) and dqs(⊥) caused by the change in rⱼ can be written as:
dqs(H,rⱼ+δrⱼ)=dqs(H,rⱼ)+D_{H,j}δrⱼ (15)
Similarly,
dqs(⊥,rⱼ+δrⱼ)=dqs(⊥,rⱼ)+D_{⊥,j}δrⱼ (16)

Applying Eq. (6) for dsp(H) to compute the new degree of support for H for (rⱼ+δrⱼ) gives

$$\begin{matrix}dsp ( H , {r}_{j} + δ {r}_{j} ) = \frac{\begin{matrix}( dqs ( H , {r}_{j} ) + {D}_{H , j} δ {r}_{j} ) - \\ ( dqs ( ⊥ , {r}_{j} ) + {D}_{⊥ , j} δ {r}_{j} )\end{matrix}}{1 - ( dqs ( ⊥ , {r}_{j} ) + {D}_{⊥ , j} δ {r}_{j} )} & ( 17 ) \\ or & \\ δ {r}_{j} = \frac{\begin{matrix}( dsp ( H , {r}_{j} + δ {r}_{j} ) ( 1 - dqs ( ⊥ , {r}_{j} ) ) - \\ ( dqs ( H , {r}_{j} ) - dqs ( ⊥ , {r}_{j} ) )\end{matrix}}{dqs ( H , {r}_{j} + δ {r}_{j} ) {D}_{⊥ , j} + {D}_{H , j} - {D}_{⊥ , j}} & ( 18 )\end{matrix}$$

provided the denominator in the above equation is not equal to 0. Thus Eq. (18) yields the change in assumption probability required to achieve the desired PAS output for dsp(H). Similar equations can be computed for other PAS outputs.
Approximate Method

To find an approximate solution for the hypothesis H posed in equation 14, we note that Eq. (17) can also be represented using a Taylor series expansion. In theory an infinie order expansion will also provide an exact solution. By limiting the order of the expansion we can reduce the computational complexity of the solution and provide a good estimate when certain constraints are satisfied.

Let dsp(H, r) represent the degree of support for H, dsp(H), for the given values of assumption probabilities r={rⱼ|rⱼεR_{dsp(H)}}, and dsp(H,r+δr) represent dsp(H,r) with differential change δr in r. A 1^{st} order Taylor expansion of dsp(H,r+δr) is given by:

$$dsp ( H , r + δ r ) ≅ dsp ( H , r ) + {\sum }_{{r}_{j} ∈ {R}_{dsp ( H )}} {w}_{j} δ {r}_{j} \qquad ( 19 )$$

where wⱼ is the partial derivative of dsp(H) with respect to rⱼ at its current value rⱼ₀:

$${w}_{j} = {[ \frac{\partial dsp ( H )}{\partial {r}_{j}} ]}_{{r}_{j 0 }} , {r}_{j} ∈ {R}_{dsp ( H )} \qquad ( 20 )$$

Since equations (5) and (6) provide a closed-form formula for dsp(H), the sensitivity values can be computed using Eq. (20) exactly once the arguments βᵢ are obtained. From Eq.(6), Eq.(20) can be expanded into the following:

$${w}_{j} = {[ \begin{matrix}\frac{1}{1 - dqs ( ⊥ )} ( \frac{\partial dqs ( H )}{\partial {r}_{j}} - \frac{\partial dqs ( ⊥ )}{\partial {r}_{j}} ) + \\ \frac{dqs ( H ) - dqs ( ⊥ )}{{( 1 - dqs ( ⊥ ) )}^{2}} \frac{\partial dqs ( ⊥ )}{\partial {r}_{j}}\end{matrix} ]}_{{r}_{j 0}} \qquad ( 21 )$$

Expanding Eq. (19),

$$dsp ( H , r ) + δ dsp ( H ) ≅ dsp ( H , r ) + {\sum }_{{r}_{j} ∈ {R}_{dsp ( H )}} {w}_{j} δ {r}_{j} \qquad ( 22 )$$

where δdsp(H) is the change in dsp(H) brought by δr, and solving for δrᵢ for some i, rᵢεR_{dsp(H)}, we get

$$δ {r}_{i} ≅ \frac{δ dsp ( H ) - {\sum }_{{r}_{j} ∈ {R}_{dsp ( H )} , j \neq i} {w}_{j} δ {r}_{j}}{{w}_{i}} \qquad ( 23 )$$

Even under the constraint 0≦rⱼ₀+δrⱼ≦1, this is an under-determined problem. Since there are more variables than constraints there are many possible solutions. The problem can be further constrained by computing δrᵢ values for a desired δdsp(I) with δrⱼ=0, ∀i≈j. In other words, only one element of R_{dps(H)} is allowed to change at a time. With this constraint, as many as t solutions exist. When multiple solutions are possible, they can be rank ordered on the basis of their magnitude (δrᵢ) or relative change (δrᵢ/rᵢ₀) to suit the user's need.

The computed δrᵢ from Eq. (23) is only an estimate but is computationally less complex than the exact method described in equation (18). As can be seen from (5) and (6), dsp(H) is a non-linear function of the elements in d_{dsp(H)}. Therefore partial derivatives are an indication of the local sensitivity only and the δrᵢ estimates are only accurate when changes in the assumption probabilities δrᵢ are small. As the sensitivity values change when we move away from the current values of the assumption probabilities rᵢ₀, the δrᵢ estimate will become increasingly inaccurate. Therefore, the closed-form solution would be used to solve for δrᵢ that satisfy a certain dsp(H) requirement that may call for a relatively large value in δrᵢ.

Relative Constraints

The inference goal can also be expressed as a relative constraint that involves a pair of hypotheses. In this case, the changes in assumption probability rⱼ that are required such that the difference or the ratio of degrees-of-support of two hypotheses reaches a certain desired value are found. One such example is the difference constraint:
dsp(H₁, rⱼ+δrⱼ)−dsp(H₂, rⱼ+δrⱼ)≧ε₁ (24)
which says that the degree of support for H₁ under the new assumption probability rⱼ+δrⱼ must be larger than that for H₂ by at least ε₁. Another example is the ratio constraint, which can be expressed as

$$\frac{dsp ( {H}_{1} , {r}_{j} + δ {r}_{j} )}{dsp ( {H}_{2} , {r}_{j} + δ {r}_{j} )} \geq {ɛ}_{2} \qquad ( 25 )$$

Constraints in Eq. (24) and Eq. (25) can also be in the forms of equality (“=”) or less than (“≧”).

To satisfy the difference and ratio constraints equation (17) for the closed-form solution is substituted into equations (24) and (25) giving two linear inequalities each with only one variable (δrⱼ) that can be easily solved. For the difference constraint,

$$\begin{matrix}\frac{( dsp ( {H}_{1} , {r}_{j} ) + {D}_{{H}_{1 , j}} δ {r}_{j} ) - ( dqs ( {H}_{2} , {r}_{j} ) + {D}_{{H}_{2 , j}} δ {r}_{j} )}{( 1 - ( dqs ( ⊥ , {r}_{j} ) + {D}_{⊥ , j} δ {r}_{j} ) )} \geq {ɛ}_{1} & ( 26 ) \\ or & \\ δ {r}_{j} \geq \frac{dqs ( {H}_{2} , {r}_{j} ) - dqs ( {H}_{1} , {r}_{j} ) + {ɛ}_{1} ( 1 - dqs ( ⊥ , {r}_{j} ) )}{{D}_{{H}_{1 , j}} - {D}_{{H}_{2 , j}} - {ɛ}_{1} \cdot {D}_{⊥ , j}} & ( 27 )\end{matrix}$$

For the ratio constraint,

$$\begin{matrix}\frac{( dqs ( {H}_{1} , {r}_{j} ) + {D}_{{H}_{1 , j}} δ {r}_{j} ) - ( dqs ( ⊥ , {r}_{j} ) + {D}_{⊥ , j} δ {r}_{j} )}{( dqs ( {H}_{2} , {r}_{j} ) + {D}_{{H}_{2 , j}} δ {r}_{j} ) - ( dqs ( ⊥ , {r}_{j} ) + {D}_{⊥ , j} δ {r}_{j} )} \geq {ɛ}_{2} & ( 28 ) \\ or & \\ δ {r}_{j} \geq \frac{\begin{matrix}dqs ( ⊥ , {r}_{j} ) + dqs ( {H}_{1} , {r}_{j} ) + \\ {ɛ}_{2} ( dqs ( {H}_{2} , {r}_{j} ) - dqs ( ⊥ , {r}_{j} ) )\end{matrix}}{{D}_{{H}_{1 , j}} - {D}_{⊥ , j} - {ɛ}_{2} ( {D}_{{H}_{2 , j}} - {D}_{⊥ , j} )} & ( 29 )\end{matrix}$$

Multi-State Assumptions

So far it has been assumed that all logical statements in the knowledge base stand on their own rights. In PAS terms, the assumptions are binary in the sense that only the assumption literal or its negation appears in any disjoint arguments (see Eq. (4)). In other words, all the assumption probabilities rⱼ=Pr(aⱼ) are mutually independent and free to take any value between 0 and 1. Therefore changing an assumption probability Pr(aⱼ) by a certain amount also means changing Pr(˜aⱼ) in the opposite direction by the same amount.

In a more general case, assumptions may exist whose probabilities are not independent and are subject to the constraint that their sum must equal to 1. In this case, changing one assumption probability in a certain way does not completely specify how the probabilities of other dependent assumptions should be changed, unlike the binary case. In the following, a formulation is developed for this more general case having multiple assumptions with dependent probability values. For simplicity, assumptions whose probabilities are not dependent on the probabilities of other assumptions are referred to as independent assumptions, and assumptions whose probabilities are subject to “sum-to-one” constraints with those of other assumptions are referred to as dependent assumptions.

To generalize to the case of dependent assumptions, the set of assumptions A_{E}, will be expanded to include all dependent and independent assumptions. For dependent assumptions, all assumption literals are included in the set A_{E}. For independent assumptions, the assumption literals and their negations are included. For simplicity, all literals in A_{E} are treated as being dependent on some other literals in the set in the sense that their probabilities must add up to 1.

Now Eq. (4) is generalized:

$$Pr ( con ( {β}_{i} ) ) = {\prod }_{x ∈ {β}_{i}} Pr ( x ) , \\ where = Pr ( x ) = {r}_{j} , \\ if x = {a}_{j} , {a}_{j} ∈ {β}_{i} \qquad ( 30 )$$

Eq. (5) for calculating the degree of quasi-support remains the same when Eq. (30) is used.

Given aεA_{E}, set w(a)⊂A_{E} is defined to be the set that includes all the dependent assumption related to a. That is,

$$w ( a ) ⊆ {A}_{E} , a ∈ {A}_{E} , {\sum }_{x ∈ w ( a )} Pr ( x ) = 1 , \qquad ( 31 )$$

From Eq. (5), the partial derivative of dqs(H) and dqs(⊥) with respect to rⱼ can now be rewritten as

$${D}_{H , j} ≡ \frac{\partial dqs ( H )}{\partial {r}_{j}} = {\sum }_{{β}_{i} ∈ {S}_{qs} ( H ) , a ∈ {β}_{i}} ( \frac{\partial Pr ( a )}{\partial {r}_{j}} {\prod }_{x ∈ {β}_{i} - \{ a \}} Pr ( x ) ) \\ {D}_{⊥ , j} ≡ \frac{\partial dqs ( ⊥ )}{\partial {r}_{j}} = {\sum }_{{β}_{i} ∈ {S}_{qs} ( ⊥ ) , a ∈ {β}_{i}} ( \frac{\partial Pr ( a )}{\partial {r}_{j}} {\prod }_{x ∈ {β}_{i} - \{ a \}} Pr ( x ) ) \qquad ( 32 )$$

where αεw(αⱼ) and Pr(αⱼ)=rⱼ.

Note that since βᵢ are disjoint, at most one assumption within a set of dependent assumptions w(aⱼ) can appear in any argument βᵢ. As mentioned earlier, changing the probability of one assumption aⱼ in the set of dependent assumptions w(aⱼ) does not uniquely specify the probability distribution over the set of assumptions when the set size is greater than 2. The proportional scheme of assigning probabilities (supra Chan and Darwich) is used to specify such a probability distribution in a deterministic way. In this scheme, if rⱼ=Pr(aⱼ) is changing, then the probabilities for the assumptions in the rest of the set w(αⱼ) are computed as follows:

$$Pr ( {a}_{k} ) = {r}_{k} = \frac{{r}_{k 0}}{1 - {r}_{j 0}} ( 1 - {r}_{j} ) , {a}_{k} ∈ w ( {a}_{j} ) , k \neq j \qquad ( 33 )$$

where rₖ₀ is the initial probability for assumption aₖεw(aⱼ), and rⱼ₀ is the initial value for rⱼ. Based on Eq. (33), the partial derivatives of Pr(a) with respect to rⱼ in Eq. (32) are

$$\frac{\partial Pr ( a )}{\partial {r}_{j}} = \{ \begin{matrix}1 , & if a = {a}_{j} ∈ {β}_{i} \\ \frac{- {r}_{k 0}}{1 - {r}_{j 0}} , & if a = {a}_{k} ∈ {β}_{i} , {a}_{k} ∈ w ( a ) , k \neq j\end{matrix} \qquad ( 34 )$$

Now Eq. (34) is substituted into Eq. (32) to complete the derivation of D_{H,j} and D_{⊥,j}. Since the derivatives in Eq. (34) are constants, D_{H,j} and D_{⊥,j} are also constants. Therefore the formulation (Eq. (18), (23), (27), and (29)), for sensitivity analysis developed in previous section for binary assumptions is still valid.

### Parameter Tuning Example: The Diabetes Inference Problem

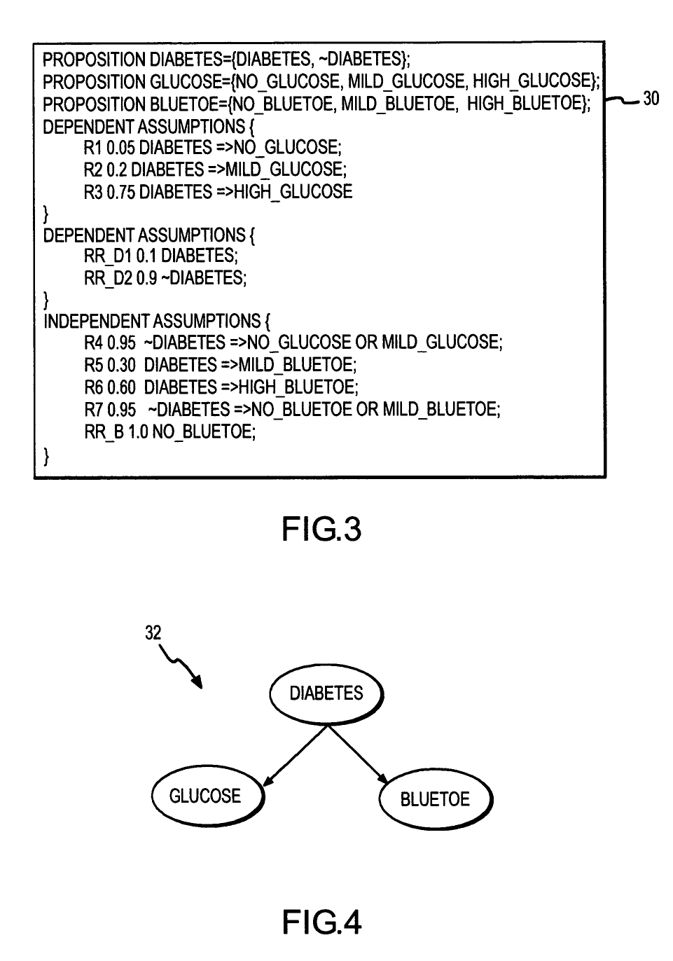

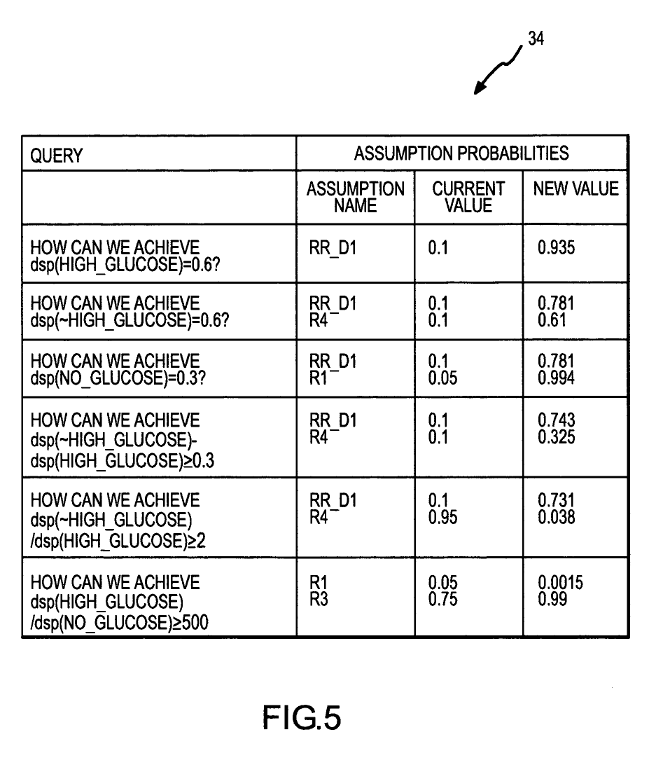

An illustrative example of sensitivity analysis in a PAS framework and specifically the parameter tuning problem is shown in FIG. 3 and described using a pseudo code 30 with PAS semantics in mind. The corresponding graph representation 32 is shown in FIG. 4. The example is about a diagnosis problem for diabetes based on some observed symptoms. Expert knowledge is translated into rules that are represented as logical statements in PAS framework. The strength with which the expert believes in each rule is expressed as assumption probabilities. Notice that this problem is similar to a Bayesian network, but differs in that many of the assumption probabilities do not follow probability constraints. Therefore it cannot be represented and reasoned upon using standard Bayesian reasoning.

There are 3 propositions in this example of a diabetes inference problem:
Diabetes: a binary proposition with 2 states {Diabetes, ˜Diabetes}
Glucose: a multi-valued proposition with 3 states {No_Glucose, Mild_Glucose, High_Glucose},
Bluetoe: a multi-valued proposition with 3 states {No_Bluetoe, Mild_Bluetoe, High_Bluetoe}.
The logical statement follows the following simple syntax:

<assumptionName> <assumptionProbability> <logicalStatement>

The logical statements can contain any propositional logic operators such as IMPLY (or =>), NOT, AND and OR. The logical statements for dependent and independent assumptions are grouped in separate blocks. The statements in each dependent assumption block have dependent assumption probabilities, which must add up to 1.0. There is no such constraint for the assumption probabilities in the independent assumptions block.

In the current example, the input condition of a test report for “no bluetoe” has been incorporated in the set of logical statements in the knowledge base as:

RR_B 1.0 No_Bluetoe;

thereby demonstrating the uniform treatment of knowledge base information and system inputs.

For this example, the objective is to make certain inference queries and then determine how to change the knowledge base to achieve different desired inference results.

Steps in Computing dsp(H)

As an example, the main steps and intermediate results for computing the query “What is dsp(High_Glucose)?” are shown.
1. The quasi-supports of the hypothesis High_Glucose and the contradiction ⊥ in the DNF form given by Eq. (2) are computed using the logic resolution process.
Quasi-support for High-Glucose:
Con(β1) [symbol] Con(β2) [symbol] Con(β3) [symbol] Con(β4),where
Con(β1)=(β3) [symbol] (R_D1)
Con(β2)=(R1|R2) [symbol] (R6) [symbol] (RR_B) [symbol] (RR_D1)
Con(β3)=(R1|R2) [symbol] (R5) [symbol] (˜R6) [symbol] (RR_B) [symbol] (RR_D1)
Con(β4)=(R1|R2) [symbol] (R5) [symbol] (R6) [symbol] (˜RR_B) [symbol] (RR_D1)

Note that all of the arguments β1-β4 in the above DNF are mutually disjoint. Each argument is a conjunction of many assumptions and the state of the assumptions for making an argument true makes the probability of every other argument in the above form 0.
Quasi-support for contradiction ⊥:
Con(β5) [symbol] Con(β6) [symbol] Con(β7), where
Con(β5)=(R6) [symbol] (RR_B) [symbol] (RR_D1)
Con(β6)=(R5) [symbol] (˜R6) [symbol] (RR_B) [symbol] (RR_D1)
Con(β7)=(R5) [symbol] (R6) [symbol] (˜RR_B) [symbol] (RR_D1)

In the above, the symbols R1-R6, RR_D1 and RR_B correspond to the assumptions in the knowledge base 30.
2. Using Equations (4) (or (34)) and (5), dqs(High_Glucose) and dqs(⊥) are computed.

Degree of quasi-support of High_Glucose:
dqs(High_Glucose)=0.093000

Degree of quasi-support for contradiction:
dqs(⊥)=0.072000

Using (6), dsp(High_Glucose) can be derived from the dqs(High_Glucose) and dqs(⊥) shown above. This gives the degree of support of High_Glucose:
dsp(High_Glucose)=0.022629

In this example, the set R_{dsp(H)} in this example is of length t=7 and its elements rⱼ are the probabilities of these assumptions: {R1, R2, R3, R5, R6, RR_B, RR_D1}.

### SENSITIVITY ANALYSIS EXAMPLES

Now suppose the objective is to perform sensitivity analysis to find out “How can we achieve dsp(High_Glucose)=0.6?”. The suggested changes in the probabilities of the assumptions in the set R_{dsp(High}_{_{—}}_{Glucose)} are computed by using the method described above for a closed form solution (Eqs.(18), (32) and (34)). It turns out that only one valid solution is obtained in this case: δRR_D1=0.835, i.e., to increase RR_D1 from 0.1 to 0.935. Thus, if the dependent assumption block for RR_D1 and RR_D2 in the knowledge base (see FIG. 3) is replaced with

```
Dependent Assumptions {
      RR_D1 0.935 Diabetes;
      RR_D2 0.065 ˜Diabetes;
      }
the goal of dsp(High_Glucose)=0.6 is achievable.
```

This example is shown as Query 1 in table 34 of FIG. 5. The table also shows a number of other examples to demonstrate the sensitivity analysis method for parameter tuning. Depending on the query, only the assumptions whose probabilities appear in the query results are analyzed. Other assumptions need not be considered since they have no effect on the query. Only valid solutions are shown, i.e., where the suggested changes give solutions in the range [0,1] consistent with a probability number. Queries 1-3 are examples of a simple query. Queries 4-6 are examples of more complex queries, i.e., queries with difference and ratio constraint.

In Query 3 “How can we achieve dsp(No_Glucose)=0.3?”, changing R1 from 0.05 to 0.994 achieves the desired dsp(No_Glucose). Since R1 is a member of a set of dependent assumptions (assumptions R1-R3) whose probabilities must sum to 1, what are the corresponding changes in R2 and R3? For the exact method, the new values for R2 and R3 were 0.001202 and 0.004511, respectively. These changes are in proportion to their original values.

The results of the approximate method are not shown in Table 1. The approximate method sometimes gives the same answer as the exact method, but often it gives different answers. Because of this, it fails to find all of the possible valid answers that will achieve the desired results. Therefore, the approximate method should only be used to estimate the sensitivity of system outputs with respect to the assumption probabilities in the neighborhood of their current values.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A sensitivity analysis method built upon a Probabilistic Argument System (PAS) framework including a knowledge base, sets of assumptions (aⱼ) and associated assumption probabilities (rⱼ), comprising:
querying the knowledge base to determine the quasi-support that will make a hypothesis H true or make the knowledge base a contradiction ⊥;
finding disjoint arguments of the quasi-support for both the hypothesis and contradiction;
forming symbolic formulas dqs(H) and dqs(⊥) for the degree of quasi-support for hypothesis H and contradiction ⊥ based on the disjoint arguments;
computing partial derivatives D_{H,j} and D_{⊥,j} of dqs(H) and dqs(⊥), respectively, with respect to the assumption probabilities rⱼ; and
forming sensitivity analysis formulas from the partial derivatives that establish the relationship between a PAS output, g(H), and the assumption probabilities under a given input condition.

2. The method of claim 1, wherein the knowledge base can be either Bayesian or non-Bayesian.

3. The method of claim 1, wherein the assumptions have independent probabilities, the partial derivatives D_{H,j} and D_{⊥,j} computed according to:
$${D}_{H , j} = {\sum }_{{{β}_{i} ∈ {S}_{qs} ( H ) ,}_{{β}_{i} ⋀ ( {a}_{j} ⋁ a \sim {a}_{j} ) = ∅}} {( - 1 )}^{s ( {a}_{j} )} {\prod }_{x ∈ {β}_{i} - \{ {a}_{j} , \sim {a}_{j} \}} Pr ( x ) , \\ and$$
$${D}_{⊥ , j} = {\sum }_{{{β}_{i} ∈ {S}_{qs} ( ⊥ ) ,}_{{β}_{i} ⋀ ( {a}_{j} ⋁ a \sim {a}_{j} ) = ∅}} {( - 1 )}^{s ( {a}_{j} )} {\prod }_{x ∈ {β}_{i} - \{ {a}_{j} , \sim {a}_{j} \}} Pr ( x )$$
where aⱼεβᵢ or ˜aⱼεβᵢ and βᵢεS_{qs}(H) where S_{qs}(H) and S_{qs}(⊥) are the sets of disjoint arguments βᵢ of quasi-support for H and ⊥, respectively, and
$$s ( {a}_{j} ) = \{ \begin{matrix}0 , & if {a}_{j} ∈ {β}_{i} \\ 1 , & if \sim {a}_{j} ∈ {β}_{i }\end{matrix} .$$

4. The method of claim 1, wherein the assumptions have dependent probabilities, the partial derivative D_{H,j} and D_{⊥,j} is computed according to:
$${D}_{H , j} = {\sum }_{{β}_{i} ∈ {S}_{qs} ( H ) , a ∈ {β}_{i}} ( \frac{\partial Pr ( a )}{\partial {r}_{j}} {\prod }_{x ∈ {β}_{i} - \{ a \}} Pr ( x ) ) , \\ and$$
$${D}_{⊥ , j} = {\sum }_{{β}_{i} ∈ {S}_{qs} ( ⊥ ) , a ∈ {β}_{i}} ( \frac{\partial Pr ( a )}{\partial {r}_{j}} {\prod }_{x ∈ {β}_{i} - \{ a \}} Pr ( x ) )$$
where
aεw(aⱼ) and Pr(aⱼ)=rⱼ;
$$Pr ( {a}_{k} ) = {r}_{k} = \frac{{r}_{k 0}}{1 - {r}_{j 0}} ( 1 - {r}_{j} ) ,$$
aₖεw(aⱼ), k≈j; and
S_{qs}(H) and S_{qs}(⊥) are the set of disjoint arguments βᵢ of quasi-support for H and ⊥, respectively, and w(aⱼ) is the set of dependent assumptions related to aⱼ whose probabilities sum up to 1.0.

5. The method of claim 1, wherein the PAS output g(H) is selected from one of degree of support dsp(H)=(dqs(H)-dqs(⊥))/(1-dqs(⊥)), degree of possibility dps(H)=1-dsp(˜H)=(1-dqs(˜H))/(1-dqs(⊥)), and degree of doubt ddb(H)=dsp(˜H), for hypothesis H.

6. The method of claim 1, wherein the sensitivity analysis formula computes sensitivity values wⱼ as the partial of the PAS output g(H) with respect to the assumption probabilities rⱼ.

7. The method of claim 6, wherein the sensitivity values wⱼ are ranked to identify the assumption probabilities to which the PAS output is most sensitive.

8. The method of claim 1, wherein the sensitivity analysis formulas determine the change δrⱼ needed in the assumption probabilities rⱼ to achieve a desired value for the PAS output g(H).

9. The method of claim 8, wherein the formula specifies δrⱼ such that g(H,rⱼ+δrⱼ)=ε where ε is the desired value for the PAS output g(H) for hypothesis H.

10. The method of claim 8, wherein the formula specifies δrⱼ such that g(H₁,rⱼ+δrⱼ)-g(H₂,rⱼ+δrⱼ)≧ε where g( ) is the PAS output and ε is the desired difference between the PAS output for hypotheses H₁ and H₂.

11. The method of claim 8, wherein the formula specifies δrⱼ such that g(H₁,rⱼ+δrⱼ)/g(H₂,rⱼ+δrⱼ)≧ε where ε is the desired ratio between the PAS output for hypotheses H₁ and H₂.

12. The method of claim 8, wherein a closed-form solution for changes in assumption probabilities for the degree of support dsp(H) PAS output is computed as:
$$δ {r}_{j} = \frac{( dsp ( H , {r}_{j} + δ {r}_{j} ) ( 1 - dqs ( ⊥ , {r}_{j} ) ) - ( dqs ( H , {r}_{j} ) - dqs ( ⊥ , {r}_{j} ) )}{dsp ( H , {r}_{j} + δ {r}_{j} ) {D}_{⊥ , j} + {D}_{H , j} - {D}_{⊥ , j}} .$$

13. The method of claim 8, wherein a first order approximate solution for changes in assumption probabilities is computed as:
$$δ {r}_{j} ≅ \frac{δ g ( H ) - {\sum }_{{r}_{j} ∈ {R}_{g ( H ) , j \neq i}} {w}_{j} δ {r}_{j}}{{w}_{i}} and$$
$${w}_{j} = {[ \frac{\partial g ( H )}{\partial {r}_{j}} ]}_{{r}_{j 0}}$$
is the partial derivative of the PAS output with respect to the assumption probability rⱼεR_{g(H)} evaluated at the probability's original value, and R_{g(H)} is the set of all assumption probabilities that appear in the PAS output g(H).

14. A sensitivity analysis method built upon a Probabilistic Argument System (PAS) framework including a knowledge base, sets of assumptions (aⱼ) and associated assumption probabilities (rⱼ) and characterized by symbolic formulas dqs(H) and dqs(⊥) for the degree of quasi-support for a hypothesis H and a contradiction I, comprising:
computing partial derivatives D_{H,j} and D_{⊥,j} of dqs(H) and dqs(⊥), respectively, with respect to the assumption probabilities rⱼ; and
forming sensitivity analysis formulas from the partial derivatives that establish the relationship between a PAS output g(H) and the assumption probabilities under a given input condition.

15. The method of claim 14, wherein the assumptions have independent probabilities, the partial derivatives D_{H,j} and D_{⊥,j} computed according to:
$${D}_{H , j} = {\sum }_{{{β}_{i} ∈ {S}_{qs} ( H ) ,}_{{β}_{i} ⋀ ( {a}_{j} ⋁ \sim {a}_{j} ) \neq ∅}} {( - 1 )}^{s ( {a}_{j} )} {\prod }_{x ∈ {β}_{i} - \{ {a}_{j} , \sim {a}_{j} \}} Pr ( x ) , and$$
$${D}_{⊥ , j} = {\sum }_{{{β}_{i} ∈ {S}_{qs} ( ⊥ ) ,}_{{β}_{i} ⋀ ( {a}_{j} ⋁ \sim {a}_{j} ) \neq ∅}} {( - 1 )}^{s ( {a}_{j} )} {\prod }_{x ∈ {β}_{i} - \{ {a}_{j} , \sim {a}_{j} \}} Pr ( x )$$
where aⱼεβᵢ or ˜aⱼεβᵢ and βᵢεS_{qs}(H) where S_{qs}(H) and S_{qs}(⊥) are the sets of disjoint arguments βᵢ of quasi-support for H and ⊥, respectively, and
$$s ( {a}_{j} ) = \{ \begin{matrix}0 , & if {a}_{j} ∈ {β}_{i} \\ 1 , & if \sim {a}_{j} ∈ {β}_{i}\end{matrix} .$$

16. The method of claim 14, wherein the assumptions have dependent probabilities, the partial derivative D_{H,j} and D_{⊥,j} is computed according to:
$${D}_{H , j} = {\sum }_{{β}_{i} ∈ {S}_{qs} ( H ) , a ∈ {β}_{i}} ( \frac{\partial Pr ( a )}{\partial {r}_{j}} {\prod }_{x ∈ {β}_{i} - \{ a \}} Pr ( x ) ) , and$$
$${D}_{⊥ , j} = {\sum }_{{β}_{i} ∈ {S}_{qs} ( ⊥ ) , a ∈ {β}_{i}} ( \frac{\partial Pr ( a )}{\partial {r}_{j}} {\prod }_{x ∈ {β}_{i} - \{ a \}} Pr ( x ) )$$
where
aεw(aⱼ) and Pr(aⱼ)=rⱼ;
$$Pr ( {a}_{k} ) = {r}_{k} = \frac{{r}_{k 0}}{1 - {r}_{j 0}} ( 1 - {r}_{j} ) , {a}_{k} ∈ w ( {a}_{j} ) , k \neq j ; and$$
S_{qs}(H) and S_{qs}(⊥) are the set of disjoint arguments βᵢ of quasi-support for H and ⊥, respectively, and w(aⱼ) is the set of dependent assumptions related to aⱼ whose probabilities sum up to 1.0.

17. The method of claim 14, wherein the PAS output g(H) is selected from one of degree of support dsp(H)=(dqs(H)-dqs(⊥))/(1-dqs(⊥)), degree of possibility dps(H)=1-dsp(˜H)=(1-dqs(˜H))/(1-dqs(⊥)), and degree of doubt ddb(H)=dsp(˜H), for hypothesis H.

18. The method of claim 17, wherein the sensitivity analysis formulas determine the change δrⱼ needed in the assumption probabilities rⱼ to achieve a desired value for the PAS output g(H).

19. The method of claim 18, wherein a closed-form solution for changes in assumption probabilities for the degree of support dsp(H) PAS output is computed as:
$$δ {r}_{j} = \frac{\begin{matrix}( dsp ( H , {r}_{j} + δ {r}_{j} ) ( 1 - dqs ( ⊥ , {r}_{j} ) ) ) - \\ ( dqs ( H , {r}_{j} ) - dqs ( ⊥ , {r}_{j} ) )\end{matrix}}{dsp ( H , {r}_{j} + δ {r}_{j} ) {D}_{⊥ , j} + {D}_{H , j} - {D}_{⊥ , j}} .$$

20. The method of claim 18, wherein a first order approximate solution for changes in assumption probabilities is computed as:
$$δ {r}_{j} ≅ \frac{δ g ( H ) - {\sum }_{{r}_{j} ∈ {R}_{g ( H ) , j \neq i}} {w}_{j} δ {r}_{j}}{{w}_{i}} and$$
$${w}_{j} = {[ \frac{\partial g ( H )}{\partial {r}_{j}} ]}_{{r}_{j 0}}$$
is the partial derivative of the PAS output with respect to the assumption probability rⱼεR_{g}(H) evaluated at the probability's original value, and R_{g(H)} is the set of all assumption probabilities that appear in the PAS output function g(H).

21. A system for performing sensitivity analysis built upon a Probabilistic Argument System (PAS) framework, comprising:
a knowledge base including sets of assumptions (aⱼ) and associated assumption probabilities (rⱼ) and characterized by symbolic formulas dqs(H) and dqs(⊥) for the degree of quasi-support for hypothesis H and contradiction ⊥, and
a computer adapted to compute partial derivatives D_{H,j} and D_{⊥,j} of dqs(H) and dqs(⊥), respectively, with respect to the assumption probabilities rⱼ, and, in response to a query, form sensitivity analysis formulas from the partial derivatives that establish the relationship between a PAS output g(H) and the assumption probabilities rⱼ under a given input condition.

22. The system of claim 21, wherein the assumptions have independent probabilities, said computer computing the partial derivatives D_{H,j} and D_{⊥,j} according to:
$${D}_{H , j} = {\sum }_{{{β}_{i} ∈ {S}_{qs} ( H ) ,}_{{β}_{i} ⋀ ( {a}_{j} ⋁ \sim {a}_{j} ) \neq ∅}} {( - 1 )}^{s ( {a}_{j} )} {\prod }_{x ∈ {β}_{i} - \{ {a}_{j} , \sim {a}_{j} \}} Pr ( x ) , and$$
$${D}_{⊥ , j} = {\sum }_{{{β}_{i} ∈ {S}_{qs} ( ⊥ ) ,}_{{β}_{i} ⋀ ( {a}_{j} ⋁ \sim {a}_{j} ) \neq ∅}} {( - 1 )}^{s ( {a}_{j} )} {\prod }_{x ∈ {β}_{i} - \{ {a}_{j} , \sim {a}_{j} \}} Pr ( x )$$
where aⱼεβᵢ or ˜aⱼεβᵢ and βᵢεS_{qs}(H) where S_{qs}(H) and S_{qs}(⊥) are the sets of disjoint arguments βᵢ of quasi-support for H and ⊥, respectively, and
$$s ( {a}_{j} ) = \{ \begin{matrix}0 , & if {a}_{j} ∈ {β}_{i} \\ 1 , & if \sim {a}_{j} ∈ {β}_{i}\end{matrix} .$$

23. The system of claim 21, wherein the assumptions have dependent probabilities, said computer computing the partial derivative D_{H,j} and D_{⊥,j} according to:
$${D}_{H , j} = {\sum }_{{β}_{i} ∈ {S}_{qs} ( H ) , a ∈ {β}_{i}} ( \frac{\partial Pr ( a )}{\partial {r}_{j}} {\prod }_{x ∈ {β}_{i} - \{ a \}} Pr ( x ) ) , and$$
$${D}_{⊥ , j} = {\sum }_{{β}_{i} ∈ {S}_{qs} ( ⊥ ) , a ∈ {β}_{i}} ( \frac{\partial Pr ( a )}{\partial {r}_{j}} {\prod }_{x ∈ {β}_{i} - \{ a \}} Pr ( x ) )$$
where
aεw(aⱼ) and Pr(aⱼ)=rⱼ;
$$Pr ( {a}_{k} ) = {r}_{k} = \frac{{r}_{k 0}}{1 - {r}_{j 0}} ( 1 - {r}_{j} ) , \\ {a}_{k} ∈ w ( {a}_{j} ) , \\ k \neq j ; and$$
S_{qs}(H) and S_{qs}(⊥) are the set of disjoint arguments βᵢ of quasi-support for H and ⊥, respectively, and w(aⱼ) is the set of dependent assumptions related to aⱼ whose probabilities sum up to 1.0.

24. The system of claim 21, wherein the PAS output g(H) is selected from one of degree of support dsp(H)=(dqs(H)-dqs(⊥))/(1-dqs(⊥)), degree of possibility dps(H)=1-dsp(˜H)=(1-dqs(˜H))/(1-dqs(⊥)), and degree of doubt ddb(H)=dsp(˜H), for hypothesis H.

25. The system of claim 24, wherein the sensitivity analysis formulas determine the change δrⱼ needed in the assumption probabilities rⱼ to achieve a desired value for the PAS output g(H).

26. The system of claim 25, wherein the computer computes a closed-form solution for changes in assumption probabilities for the degree of support dsp(H) PAS output as:
$$δ {r}_{j} = \frac{\begin{matrix}( dsp ( H , {r}_{j} + δ {r}_{j} ) ( 1 - dqs ( ⊥ , {r}_{j} ) ) ) - \\ ( dqs ( H , {r}_{j} ) - dqs ( ⊥ , {r}_{j} ) )\end{matrix}}{dsp ( H , {r}_{j} + δ {r}_{j} ) {D}_{⊥ , j} + {D}_{H , j} - {D}_{⊥ , j}} .$$

27. The method of claim 25, wherein the computer computes a first order approximate solution for changes in assumption probabilities as:
$$δ {r}_{j} ≅ \frac{δ g ( H ) - {\sum }_{{r}_{j} ∈ {R}_{g ( H ) , j \neq i}} {w}_{j} δ {r}_{j}}{{w}_{i}} and$$
$${w}_{j} = {[ \frac{\partial g ( H )}{\partial {r}_{j}} ]}_{{r}_{j 0}}$$
is the partial derivative of the PAS output with respect to the assumption probability rⱼεR_{g(H)} evaluated at the probability's original value, and R_{g(H)} is the set of all assumption probabilities that appear in the PAS output g(H).
